(19) United States
(12) Patent Application Publication
(10) Pub. No.: US 2010/0199804 A1
(43) Pub. Date: Aug. 12, 2010

(54) ROTARY INDEX DEVICE IN MACHINE TOOL

(75) Inventor: Yoshinori Tatsuda, Ishikawa-ken (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TSUDAKOMA KOGYO KABUSHIKI KAISHA, Kanazawa-shi, Ishikawa-ken (JP)

(21) Appl. No.: 12/676,259

(22) PCT Filed: Oct. 6, 2008
(86) PCT No.: PCT/JP2008/068147

§ 371 Date: Mar. 3, 2010

(30) Foreign Application Priority Data
Oct. 10, 2007 (JP) 2007-264193

(51) Int. Cl. B23Q 16/10; B23Q 1/26

(52) U.S. Cl. 74/813 L

(57) ABSTRACT

A rotary index device in a machine tool includes a rotating shaft; and a clamp device. The clamp device includes a piston member provided displaceably in a direction along a rotational axis of the rotating shaft and having a tapered surface formed on a side surface thereof on a clamp position side, pressing force conversion means, for receiving a pressing force from the piston member when the piston member is displaced, converting the pressing force into a force in the radial direction of the rotating shaft, and causing the converted force to act on the rotational body, and urging means for urging the piston member in a direction in which the pressing force conversion means generates the pressing force in the radial direction of the rotating shaft.

### TECHNICAL FIELD

The present invention relates to a device in a machine tool, the device which rotates a rotary table and indexes to bring a workpiece on the rotary table to a predetermined rotational angle.

### BACKGROUND ART

Patent document 1 discloses a disk-type clamp device, and patent document 2 discloses a sleeve-type clamp device.

The disk-type clamp device typically has a clamp disk fixed to a rotating shaft and extending in a radial direction of the rotating shaft. An outer peripheral end portion of the clamp disk is clamped by a clamp surface of a housing and a piston member or the like after indexing of the rotating shaft. Thus, the indexed angular position of the rotating shaft is held.

Since the disk-type clamp device holds the angular position by clamping the outer peripheral end portion of the thin-plate clamp disk, a load in a rotational direction is applied to the rotating shaft during machining of a workpiece. Thus, deflection may occur between the fixed position of the clamp disk to the rotating shaft and the clamp position. Consequently, the indexed angular position of the rotating shaft may be deviated, and machining accuracy may be degraded.

In the sleeve-type clamp device, a clamp sleeve, which has a thin-wall portion formed in an outer peripheral portion thereof by providing a groove, is provided between a housing and a rotational body, and the thin-wall portion is deformed in a diameter-decreasing direction by a pressure of working fluid such as pressure oil. The deformation of the thin-wall portion causes a pressing force to act on the rotational body in a radial direction of a rotating shaft. The indexed angular position of the rotational body is held. The thin-wall portion of the clamp sleeve extends in an axial direction of the rotating shaft.

In the sleeve-type clamp device, the pressure of the working fluid, which is applied to a pressure chamber defined by the housing and the groove of the clamp sleeve, directly acts on not only the thin-wall portion but also the housing. The pressure acts on the housing in the radial direction of the rotating shaft. In some cases, the housing may be bent. If the housing is bent, the rotating shaft supported by the housing through a bearing or the like may be inclined. Consequently, the machining accuracy may be degraded.

[Patent Document 1] Japanese Unexamined Patent Application Publication No. 10-220425

[Patent Document 2] Japanese Unexamined Patent Application Publication No. 2002-103181

### DISCLOSURE OF INVENTION

### Problems to be Solved by the Invention

Accordingly, an object of the present invention is that, in the rotary index device in the machine tool, a clamp device securely and stably holds a rotating shaft.

### Means for Solving the Problems

To attain this, according to the present invention, an annular, displaceable piston member is arranged around a rotating shaft, pressing force conversion means contacts a tapered surface of the piston member, movement of the piston member is converted into a pressing force to a rotational body, and with the pressing force, the rotational body is securely and stably held.

In particular, a rotary index device (1) in a machine tool is presupposed. The rotary index device (1) includes a rotating shaft (4) provided rotatably in a housing (2), a rotation object member (3) being fixed to an end portion of the rotating shaft (4); and a clamp device (6) that causes a pressing force to act on a rotational body (5) including the rotating shaft (4) in a radial direction of the rotating shaft (4), and holds a rotational angular position of the rotational body (5) after indexing.

Herein, the rotary index device (1) is not limited to a rotary table device, and includes a device (main-shaft head) that supports a device (spindle unit) for rotating a spindle (main shaft) to which a tool for machining a workpiece is mounted and turns the spindle unit, and a device that rotates the main-shaft head around an axis that is parallel to the Z axis of a machine tool. In the former case, the spindle unit corresponds to the rotation object member. In the later case, the main-shaft head corresponds to the rotation object member. Also, the rotational body (5) includes the rotation object member (3), the rotating shaft (4), and all other parts that rotate simultaneously with the rotating shaft (4).

In the rotary index device (1), the clamp device (6) includes a piston member (7) provided displaceably in a direction along a rotational axis of the rotating shaft (4) within the housing (2), the piston member (7) having a tapered surface (8) formed on a side surface thereof on a clamp position side; pressing force conversion means (9) arranged between the rotational body (5) and the piston member (7), for receiving a pressing force in the direction along the rotational axis of the rotating shaft (4) from the piston member (7) when the piston member (7) is displaced, converting the pressing force into a force in the radial direction of the rotating shaft (4), and causing the converted force to act on the rotational body (5); and urging means (10) for urging the piston member (7) in a direction in which the pressing force conversion means (9) generates the pressing force in the radial direction of the rotating shaft (4).

Also, in the rotary index device (1), the pressing force conversion means (9) includes a plurality of pressing members (11) provided between the piston member (7) and the rotational body (5) and arranged in a circumferential direction of the rotating shaft (4).

Further, in the rotary index device (1), the pressing members (11) are lever members (12) provided to extend in an axial direction of the rotating shaft (4), each lever member (12) having an effort portion (13), a fulcrum portion (15), and a load portion (14), the effort portion (13) formed at an end portion of the lever member (12) and contacting the tapered surface (8) of the piston member (7), the fulcrum portion (15) rotatably retained by the housing (2), the load portion (14) facing the rotating shaft (4), the lever member (12) formed such that a distance from the effort portion (13) to the fulcrum portion (15) is larger than a distance from the fulcrum portion (15) to the load portion (14).

Further, in the rotary index device (1), the clamp device (6) includes a clamp member (16) arranged between the pressing force conversion means (9) and the rotational body (5), and fixed to the housing (2) non-rotatably relative to the housing (2), the clamp member (16) facing a surface of the rotational body (5), the surface which receives the pressing force, the clamp member (16) having a ring-shaped, thin-wall cylindrical portion (17, 50) that is deformable in the radial direction of the rotating shaft (4).

Further, in the rotary index device (1), the tapered surface (8) of the piston member (7) has an angle that is smaller than 45 degrees to the rotational axis.

### ADVANTAGES

With the rotary index device (1) according to claim 1, the clamp disk extending in the radial direction of the rotating shaft is not clamped at the outer peripheral end portion of the clamp disk unlike the disk-type clamp device of the related art, or the pressure of the working fluid does not directly act on the housing in the radial direction of the rotating shaft unlike the sleeve-type clamp device of the related art. Thus, with the invention according to claim 1, since the indexed angular position is not deviated or the rotating shaft (4) is not inclined, the machining accuracy can be prevented from being degraded. In particular, since the pressing force conversion means (9) receives the pressing force from the tapered surface (8) when the piston member (7) is displaced, and the pressing force conversion means (9) causes the pressing force to act as a clamp force in the radial direction of the rotating shaft (4), the clamp force necessary for clamping can be provided. The rotating shaft (4) can be correctly clamped without the indexed angular position deviated.

According to claim 2, since the plurality of pressing members (11) are provided between the piston member (7) and the rotational body (5) and arranged in the circumferential direction of the rotating shaft (4), the clamp force can act uniformly on the circumference of the rotating shaft (4).

According to claim 3, the pressing members (11) are the lever members (12), and each lever member (12) is formed such that the distance from the effort portion (13) to the fulcrum portion (15) is larger than the distance from the fulcrum portion (15) to the load portion (14). The pressing force acting on the lever (12) from the piston member (7) is increased and then acts on the rotational body (5). Thus, a strong clamp force can be provided.

According to claim 4, the clamp member (16) fixed to the housing (2) non-rotatably relative to the housing (2) is provided, and the ring-shaped, deformable, thin-wall cylindrical portion (17), which is integrated with the clamp member (16), is arranged between the pressing force conversion means (9) and the rotational body (5). Thus, the clamp force can act substantially uniformly on a surface to be pressed of the rotational body (5). Also, the thin-wall cylindrical portion (17) frictionally contacts the surface to be pressed of the rotational body (5). Thus, a force in a rotational direction does not act on the pressing force conversion means (9) from the rotating shaft (4), and clamping becomes stable.

According to claim 5, since the angle of the tapered surface (8) of the piston member (7) to the rotational axis is smaller than 45 degrees, the pressing force acting on the lever member (12) from the piston member (7) is increased. Thus, a further strong clamp force can be provided. In particular, since the pressing force conversion means (9) is formed by combining two such force-increasing mechanisms, a strong clamp force that can be used for machining with a high load can be provided.

### BRIEF DESCRIPTION OF DRAWINGS

FIG. 1 is a sectional view showing a rotary index device 1 in a machine tool according to the present invention.

FIG. 2 is a sectional view taken along line A-A in FIG. 1.

FIG. 3 is a sectional view showing a clamp device 6 of the rotary index device 1 in the machine tool according to the present invention.

FIG. 4 is an enlarged sectional view showing a primary portion of the clamp device 6 of the rotary index device 1 in the machine tool according to the present invention.

FIG. 5 is a sectional view showing a rotary index device 1 in a machine tool according to other embodiment of the present invention.

FIG. 6 is a sectional view showing a rotary index device 1 in a machine tool according to other embodiment of the present invention.

FIG. 7 is a sectional view showing a rotary index device 1 in a machine tool according to other embodiment of the present invention.

FIG. 8 is a sectional view showing a rotary index device 1 in a machine tool according to other embodiment of the present invention.

FIG. 9 is a sectional view showing a rotary index device 1 in a machine tool according to other embodiment of the present invention.

### REFERENCE NUMERALS

1 rotary index device in machine tool
2 housing
3 rotary table (rotation object member)
4 rotating shaft
5 rotational body
6 clamp device
7 piston member
8 tapered surface
9 pressing force conversion means
10 urging means
11 pressing member
12 lever member
13 effort portion
14 load portion
15 fulcrum portion
16 clamp member
17 thin-wall cylindrical portion
18 bearing sleeve
19 attaching bolt
20 worm wheel
21 worm
22 attaching bolt
23 boss
24 bearing
25 housing hole
26 step portion
27 case member
28 attaching bolt
29 attaching bolt
30 cover
31 bolt
32 oil seal
33 pressure chamber
34 working fluid
35 attaching bolt
36 spacer
37 flange
38 fluid port
39 fluid path
40 support member
41 attaching bolt
42 spacer
43 spring member
44 guide hole
45 urging spring member
46 restoring pressure chamber
47 working fluid
48 fluid port
49 fluid path
50 thin-wall cylindrical portion
51 steel ball
52 member to be pressed
53 attaching bolt
54 elastic member

### BEST MODES FOR CARRYING OUT THE INVENTION

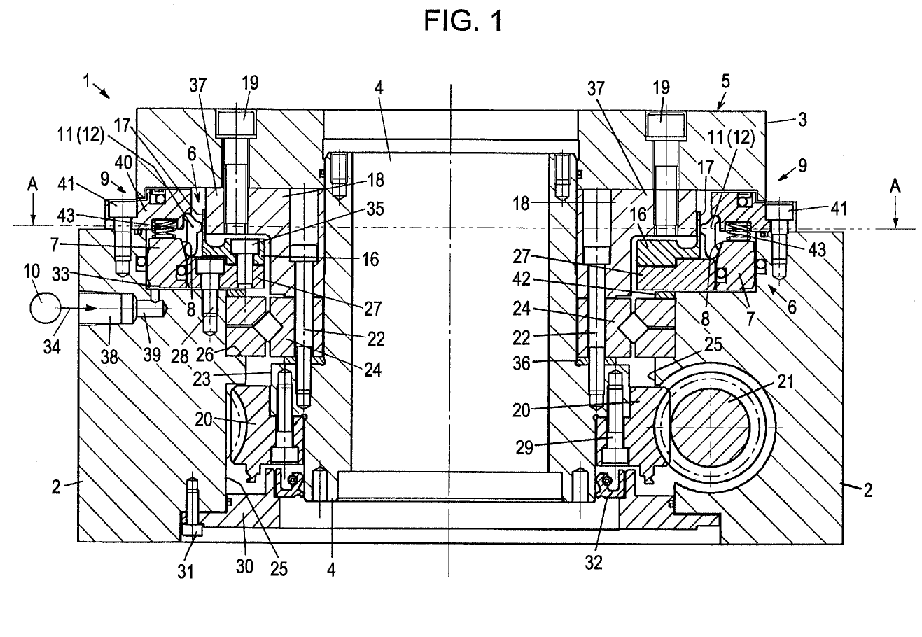

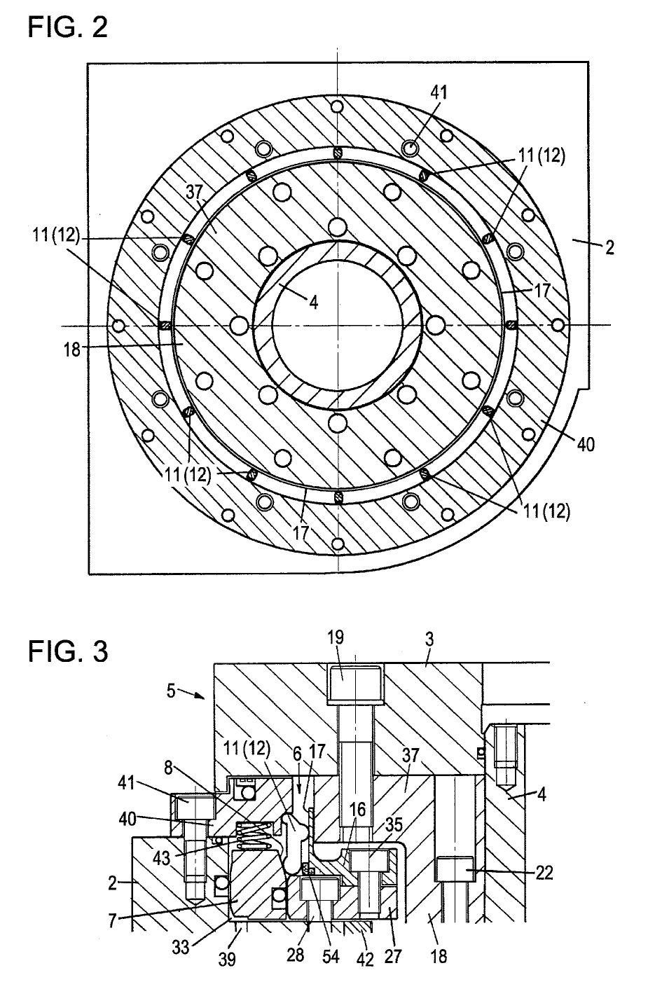

FIGS. 1 to 4 illustrate a representative embodiment in which a rotary index device 1 in a machine tool according to the present invention is applied to a rotary table device. Referring to FIGS. 1 to 4, the rotary index device 1 in a machine tool includes a rotating shaft 4 provided rotatably in a housing 2, a rotational body 5 including the rotating shaft 4, and a clamp device 6 for causing a pressing force to act on the rotational body 5 in a radial direction of the rotating shaft 4 and holding a rotational angular position of the rotational body 5 after indexing.

The rotating shaft 4 is, for example, hollow. The rotating shaft 4 is provided rotatably within a housing hole 25 of the housing 2. A rotary table 3 is relatively non-rotatably attached to an end portion of the rotating shaft 4. The rotary table 3 serves as a rotation object member. The rotary table 3 is arranged in parallel to a surface of the block-shaped housing 2. The rotary table 3 is fitted to the rotating shaft 4 at a hole portion at the center thereof, and fixed to a bearing sleeve 18, which is a part of the rotational body 5, by a plurality of attaching bolts 19.

The rotational body 5 includes the rotary table 3 serving as the rotation object member, the rotating shaft 4, the bearing sleeve 18, a worm wheel 20, and all other parts that rotate simultaneously with the rotating shaft 4. The bearing sleeve 18 is fitted on the outer periphery of the rotating shaft 4, and is attached to a boss 23 of the rotating shaft 4 by a plurality of attaching bolts 22 with an inner ring part of a bearing 24 and a spacer 36 arranged between the bearing sleeve 18 and the boss 23. Thus, the inner ring part of the bearing 24 is held by the rotating shaft 4, at a position between the boss 23 and the bearing sleeve 18. The bearing 24 is also pressed to a step portion 26 formed in the housing hole 25 of the housing 2, by a case member 27 with a spacer 42, which is provided if necessary, interposed between the bearing 24 and the step portion 26. The case member 27 is attached to the opening side of the housing hole 25 by attaching bolts 28. Hence, the bearing 24 is not movable relative to the housing 2.

The worm wheel 20 is attached to the boss 23 of the rotating shaft 4 by a plurality of attaching bolts 29. The worm wheel 20 is housed in the housing hole 25 of the housing 2. The'worm wheel 20 meshes with a worm 21 that is supported rotatably relative to the housing 2. The worm 21 is rotated by a rotational driving source such as a motor (not shown). When the worm 21 is rotated, the speed of rotation of the worm 21 is reduced by a reduction ratio between the worm wheel 20 and the worm 21, and then transmitted to the worm wheel 20. Accordingly, the rotating shaft 4 is rotated in a predetermined direction, and the rotational body 5, in particular, the rotary table 3 is indexed to a predetermined rotational angular position.

As described above, the rotation transmission path is from the worm 21 on the input side to the worm wheel 20 on the output side. The reverse rotation transmission path, in particular, the transmission of rotation from the worm wheel 20 to the worm 21 is not achieved because of a self-locking effect of a worm gear mechanism (the worm wheel 20, the worm 21). The automatic stop effect is automatically attained when the worm 21 receives a torque from the worm wheel 20. However, for example, due to backlash in the worm wheel 20 and the worm 21, the indexed rotational angular position of the rotational body 5 may not be correctly and securely held. Owing to this, to correctly and securely hold the indexed rotational angular position of the rotational body 5, the rotary index device 1 is provided with the clamp device 6.

As described above, the rotational body 5, that is, the rotary table 3, the rotating shaft 4, the bearing sleeve 18, and the worm wheel 20 are housed in the housing 2, and are driven by the worm 21. An opening plane of the housing hole 25 located near the worm wheel 20 and located between the outer peripheral side of the rotating shaft 4 and the inner peripheral side of the housing hole 25 is closed with a ring-shaped cover 30. The cover 30 is attached to the housing 2 by bolts 31. The space between the ring-shaped cover 30 and the rotating shaft 4 is closed with an oil seal 32.

The clamp device 6 is, for example, normally unclamping type. The clamp device 6 includes a piston member 7, pressing force conversion means 9, a clamp member 16, and urging means 10. The piston member 7 is an annular body. The piston member 7 is provided to surround the rotational body 5, in particular, the bearing sleeve 18 displaceably only in a direction along a rotational axis of the rotating shaft 4 within a pressure chamber 33 that is defined by the housing 2 and the annular case member 27.

In this embodiment, the piston member 7 is the annular body (ring-shaped body) and hence the pressure chamber 33 also has an annular (ring-shaped) space. However, these shapes are not limited to rings. The piston member 7 may be a plurality of members individually provided at positions respectively corresponding to the pressing members 11 and arranged in a circumferential direction of the rotating shaft 4. Also, a plurality of pressure chambers 33 may be respectively provided for the individual piston members 7. The case member 27 is located at a position on the inner peripheral side of the piston member 7, and attached to the step portion of the housing hole 25 by the attaching bolts 28 as described above.

The piston member 7 is housed within the pressure chamber 33. An outer peripheral surface of the piston member 7 is slidable on an inner wall of the housing hole 25 with a seal member interposed therebetween. An inner peripheral surface of the piston member 7 is slidable on an outer wall of the case member 27 with a seal member interposed therebetween. The piston member 7 is normally urged in a retract direction, i.e., in a normally unclamping direction, by a spring member 43 such as a compression spring that is inserted between the piston member 7 and a support member 40. The piston member 7 is displaced in an advance direction, i.e., in a clamping direction by an urging force of working fluid 34 from urging means 10.

Referring to FIG. 1, the working fluid 34 of the urging means 10 is supplied to an inner part on a retracted position side of the pressure chamber 33 through a fluid port 38 and a fluid path 39. The support member 40 is located between the rotary table 3 and the housing 2. The support member 40 is attached to the housing 2 by attaching bolts 41. The support member 40 also functions as a lid that covers the gap between the housing 2 and the rotary table 3 by pressing a seal member or the like to the surface of the rotary table 3.

The case member 27 is integrated with the annular clamp member 16. The clamp member 16 is fixed to the case member 27, which is integrated with the housing 2, non-rotatably relative to the case member 27 by attaching bolts 35. The clamp member 16 includes a thin-wall cylindrical portion 17 that is integrally formed with the clamp member 16. The thin-wall cylindrical portion 17 has a ring-like shape that is deformable in the radial direction of the rotating shaft 4. The thin-wall cylindrical portion 17 faces an outer peripheral surface of a flange 37 of the bearing sleeve 18 in a non-contact manner. The outer peripheral surface of the flange 37 of the bearing sleeve 18 contacts the thin-wall cylindrical portion 17 when the thin-wall cylindrical portion 17 is deformed, and serves as a surface that receives the pressing force (clamp force) for bringing the rotational body 5 into a clamped state.

The piston member 7 has a tapered surface 8 formed on a side surface (inner peripheral surface) on a clamp position side such that a top portion (on the upper side in the drawing) on the clamp portion side is chamfered. In this embodiment, the tapered surface 8 has an angle that is smaller than 45 degrees to the rotational axis of the rotational body 5.

The pressing force conversion means 9 is arranged between the bearing sleeve 18 and the piston member 7. The pressing force conversion means 9 receives the pressing force in the direction along the rotational axis of the rotating shaft 4 from the piston member 7 when the piston member 7 is displaced. Also, the pressing force conversion means 9 converts the pressing force into a pressing force toward the center in the radial direction of the rotating shaft 4 and causes the converted force to act on the bearing sleeve 18, so as to stop the rotation of the rotating shaft 4 and bring the rotating shaft 4 into the clamped state.

In this embodiment, the pressing force conversion means 9 includes a plurality of (regarding the balance on the circumference of the rotating shaft 4, three or more) pressing members 11 provided between the piston member 7 and the rotational body 5 and arranged in the circumferential direction of the rotating shaft 4. More specifically, in the illustrated embodiment, the pressing members 11 are twelve lever members 12 arranged to extend in an axial direction of the rotating shaft 4.

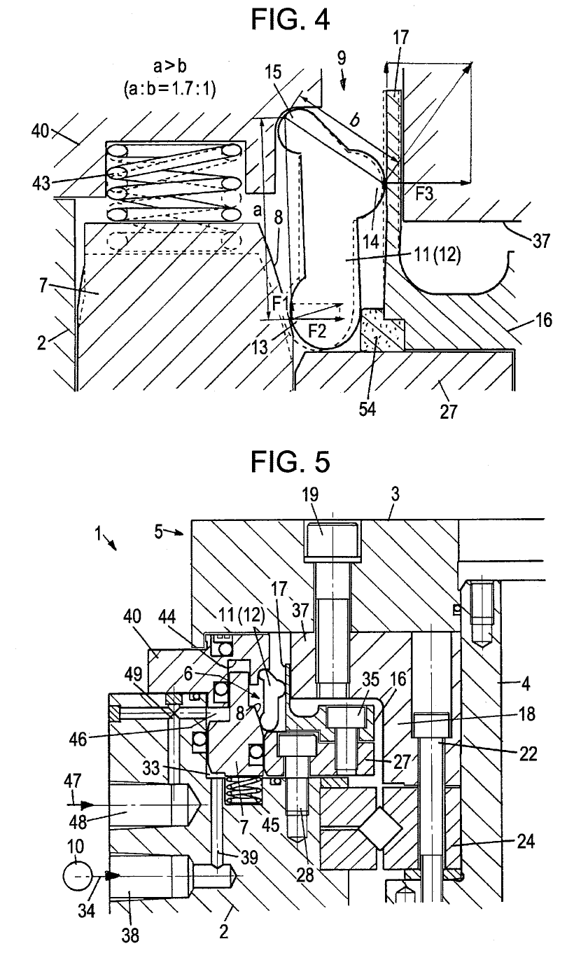

As illustrated in FIGS. 3 and 4 in an enlarged manner, each of the lever members 12 includes an effort portion 13, a fulcrum portion 15, and a load portion 14. The effort portion 13 is formed at an end portion of the lever member 12 such that the effort portion 13 contacts the tapered surface 8 of the piston member 7. The fulcrum portion 15 is rotatably retained by the support member 40 integrated with the housing 2. The load portion 14 contacts the thin-wall cylindrical portion 17 of the clamp member 16 to cause a pressing force (clamp force) to indirectly act on the rotational body 5 (the rotating shaft 4). The effort portion 13 directly contacts the tapered surface 8. The fulcrum portion 15 is directly retained in a journal recess of the support member 40. In contrast, the load portion 14 contacts the outer peripheral surface of the thin-wall cylindrical portion 17, indirectly contacts the bearing sleeve 18 which is a part of the rotational body 5, and causes the clamp force to act on the rotational body 5 (the rotating shaft 4). It is to be noted that the thin-wall cylindrical portion 17 (the clamp member 16) may be omitted. If the thin-wall cylindrical portion 17 is omitted, the load portion 14 directly causes the clamp force to act on the rotational body 5 (the rotating shaft 4).

In the lever member 12, a distance a from the effort portion 13 to the fulcrum portion 15 is larger than a distance b from the fulcrum portion 15 to the load portion 14. Thus, based on the lever rule, the pressing force acting on the effort portion 13 from the piston member 7 is increased by the ratio of a/b, thereby providing a clamp force that presses the thin-wall cylindrical portion 17 at the position of the load portion 14. As described above, the lever member 12 functions as force-increasing means based on the lever effect during clamping.

The rotational driving source drives the worm 21 and the worm wheel 20 to index the rotational body 5 to a predetermined index angle. Indexing to a predetermined angle is performed by rotation control with the rotational driving source and rotation amount control. The indexed angular position is held by the clamp device 6. More specifically, when the working fluid 34 is supplied from the urging means 10 through the fluid port 38 and the fluid path 39 to the inner part on the retracted position side of the pressure chamber 33 for clamping of the clamp device 6 after indexing of the rotational body 5, the piston member 7 is advanced (displaced to the upper side in FIG. 4) from the retracted position against the force of the spring member 43. During the advancement, the tapered surface 8 causes the effort portion 13 of the lever member 12 of the pressing member 11 to be displaced toward the center of the rotating shaft 4.

Referring to FIG. 4, when the piston member 7 is advanced, the effort portion 13 of the lever member 12 receives the pressing force in a vertical direction of the tapered surface 8 from the piston member 7. Then, a component force F1 in the displacement direction (the axial direction) of the piston member 7 and a component force F2 in the radial direction act on the effort portion 13 of the lever member 12. However, since the fulcrum portion 15 of the lever member 12 is retained, the lever member 12 is inhibited form being displaced in the axial direction. Thus, when the pressing force acts on the effort portion 13 of the lever member 12 from the piston member 7, the lever member 12 is displaced in the radial direction (toward the center) of the rotating shaft 4 by the component force F2 around the fulcrum portion 15 as the fulcrum. As described above, since the tapered surface 8 of the piston member 7 contacts the lever member 12, when the piston member 7 presses the lever member 12, the pressing force F2 toward the center, that is, in the clamping direction acts on the lever member 12. The tapered surface 8 also relates to the conversion of the pressing force from the piston member 7. Therefore, the tapered surface 8 also serves as part of pressing force conversion means 9 together with the lever member 12, which serves as the pressing member 11.

As described above, in the illustrated embodiment, the tapered surface 8 has the angle smaller than 45 degrees to the axis of the rotating shaft 4. With this configuration, the pressing force F2 is larger than the pressing force F1 in the axial direction caused by the piston member 7 to act on the lever member 12 as a result of the displacement of the piston member 7. That is, the pressing force in the axial direction acting on the pressing member 11 as a result of the displacement of the piston member 7 is increased, and then acts in the clamping direction. Accordingly, the configuration in which the piston member 7 contacts the pressing member 11 (the lever member 12) through the tapered surface 8 with the angle smaller than 45 degrees to the axis of the rotating shaft 4 defines a kind of a force-increasing mechanism.

When the effort portion 13 of the lever member 12 receives the pressing force in the clamping direction from the tapered surface 8 of the piston member 7, the lever member 12 presses the load portion 14 to the outer peripheral surface of the thin-wall cylindrical portion 17 while the fulcrum portion 15 retained by the support member 40 serves as the fulcrum, resulting in the pressing force being generated. At this time, the pressing force is increased by the ratio of a/b, which is the ratio of the distance a from the effort portion 13 to the fulcrum portion 15 to the distance b from the fulcrum portion 15 to the load portion 14, based on the lever rule. Then, the increased pressing force acts on the outer peripheral surface of the thin-wall cylindrical portion 17.

The thin-wall cylindrical portion 17 is slightly separated from the flange 37 of the bearing sleeve 18 and hence is in a non-contact state during indexing. However, when the thin-wall cylindrical portion 17 receives a large pressing force in the radial direction of the rotating shaft 4 from the load portion 14, the thin-wall cylindrical portion 17 is deformed in a direction in which the inner diameter of the thin-wall cylindrical portion 17 is decreased, and the thin-wall cylindrical portion 17 is pressed to the outer peripheral surface of the flange 37 of the bearing sleeve 18. Consequently, the bearing sleeve 18 is held by a frictional force between the inner peripheral surface of the thin-wall cylindrical portion 17 and the outer peripheral surface of the flange 37. Thus, the rotating shaft 4 integrated with the bearing sleeve 18 is clamped while idle rotation of the rotating shaft 4 is inhibited. Accordingly, the rotary table 3, the rotating shaft 4, the bearing sleeve 18, etc., which serve as the rotational body 5, are correctly and securely held by the housing 2 while the predetermined index angle is maintained after indexing.

The thin-wall cylindrical portion 17 is arranged between the flange 37 of the bearing sleeve 18 and the lever member 12, so that the load portion 14 of the lever member 12 does not directly contact the outer peripheral surface of the flange 37, and hence the rotational force does not act on the load portion 14 of the lever member 12. Also, since the thin-wall cylindrical portion 17 surrounding the flange 37 holds the flange 37, the thin-wall cylindrical portion 17 causes a holding force to act on the flange 37 substantially uniformly in the circumferential direction as compared with a case in which the lever member 12 causes a pressing force to locally act on the flange 37. The function of the thin-wall cylindrical portion 17 is advantageous for practical use, however, the thin-wall cylindrical portion 17 is not essential to the present invention, and may be omitted.

As described above, the clamp device 6 includes a force-increasing mechanism because of contact between the tapered surface 8 and the lever member 12 as the pressing member 11, and a force-increasing mechanism using the lever member 12 as the pressing member 11 that provides the lever effect. Accordingly, the pressing force caused by the piston member 7 to act on the pressing member 11 (the lever member 12) serving as the pressing force conversion means 9 is increased in two steps with the two force-increasing mechanisms.

To be more specific, referring to FIG. 4, when it is assumed that the force acting on the lever member 12 in the axial direction when the piston member 7 is displaced in the axial direction is F1, the force in the radial direction by the action of the tapered surface 8 is increased to F2 and the force F2 acts on the lever member 12. Further, the pressing force F2 acting on the lever member 12 in the radial direction is increased by an amount corresponding to the distance ratio a/b based on the lever rule, and the increased force, that is, the pressing force F3, acts on the thin-wall cylindrical portion 17. With this configuration, a strong clamp force can be provided.

FIGS. 5 to 9 illustrate clamp devices 6 according to other embodiments. First, a clamp device 6 shown in FIG. 5 is substantially similar to the clamp device 6 shown in FIGS. 1 to 4, except that the clamp device 6 in FIG. 5 is normally clamping type. A thin tip portion of a piston member 7 is guided to a guide hole 44 of a support member 40 and is slidable in a pressure chamber 33. The piston member 7 is urged in an advance direction, that is, a clamping direction by an urging spring member 45 such as a compression spring at a rear end position of the piston member 7. In this case, the urging spring member 45 serves as urging means 10 of the present invention.

Similarly to the clamp device 6 shown in FIGS. 1 to 4, the pressure chamber 33 is formed between a rear end portion of the piston member 7 and a housing 2. Working fluid 34 for urging the piston member 7 in the clamping direction is supplied to the pressure chamber 33. The working fluid 34 flows into the pressure chamber 33, and urges the piston member 7 in the clamping direction. Thus, the piston member 7 receives an urging force (clamp force) from the working fluid 34 in addition to the urging force by the urging spring member 45. With the two urging forces, the urging force (clamp force) can be increased. Of course, a mechanism for supplying the working fluid 34 to the pressure chamber 33 is included in the urging means 10. Also, a restoring pressure chamber 46 is formed on a rotary table 3 side of the piston member 7, that is, on an advance end side of the piston member 7. Working fluid 47 for unclamping is supplied through a fluid port 48 and a fluid path 49 during unclamping.

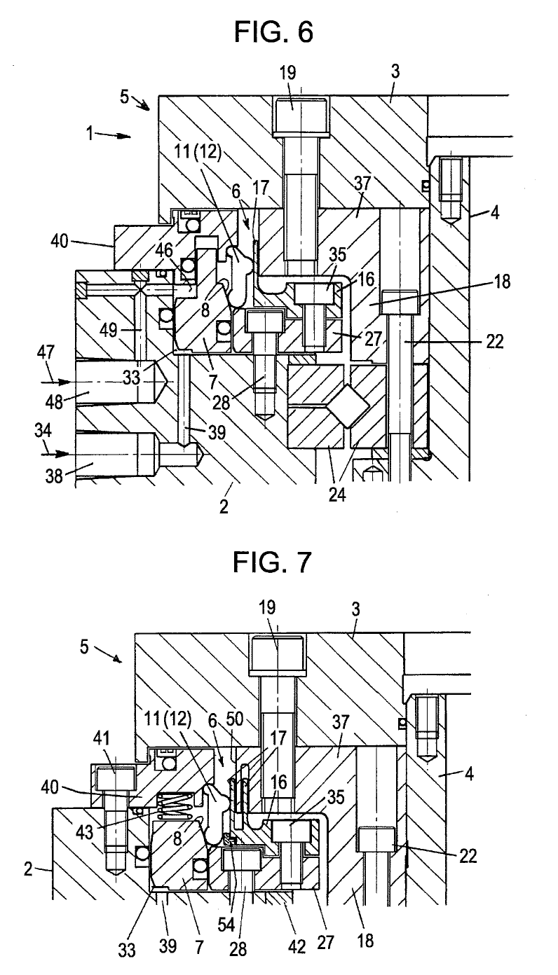

A clamp device 6 shown in FIG. 6 is different from the clamp device 6 shown in FIG. 5 in that the clamp device 6 in FIG. 6 does not include the urging spring member 45. In particular, a piston member 7 is displaced in the clamping and unclamping directions through supply of working fluid 34 for clamping or working fluid 47 for unclamping. Thus, the clamp device 6 can desirably determine a retracted position or an advanced position as a stop position of the piston member 7 through the supply of the working fluid 34 or the working fluid 47. The clamp device 6 can be normally clamping type at the retracted position, and normally unclamping type at the advanced position.

A clamp device 6 shown in FIG. 7 has a main configuration substantially similar to the configuration of the clamp device 6 shown in FIGS. 1 to 4, except that a clamp member 16 includes a plurality of thin-wall cylindrical portions 17, and a thin-wall cylindrical portion 50 is formed in a part of a rotational body 5, thereby providing a plurality of frictional portions for clamping. To be more specific, as shown in FIG. 7, the clamp member 16 includes a plurality of (in the illustrated embodiment, two) thin-wall cylindrical portions 17 which are separated from one another in the radial direction and have different diameters. Also, a bearing sleeve 18, which is a part of the rotational body 5, includes a single thin-wall cylindrical portion 50 (or two or more thin-wall cylindrical portions 50) in an outermost peripheral portion of a flange 37. The thin-wall cylindrical portion 50 is inserted into a space between the thin-wall cylindrical portions 17. In this embodiment, the bearing sleeve 18 also functions as a clamp member 16.

As described above, the single thin-wall cylindrical portion 50 extends in the axial direction of a rotating shaft 4 so as to face the two thin-wall cylindrical portions and to be arranged between the two thin-wall cylindrical portions 17. The thin-wall cylindrical portion 50 of the rotating shaft 4 is also made of a material that is bent and deformed in the radial direction in a similar manner to the thin-wall cylindrical portions 17 of the clamp member 16. With this configuration, as compared with the configuration shown in FIG. 1, the plurality of clamp portions (frictional surfaces) are provided. Accordingly, contact surfaces (clamp surfaces) where frictional forces are generated are increased, and a larger holding force (clamp force) can be generated. Of course, the number of thin-wall cylindrical portions 50 may be two or more.

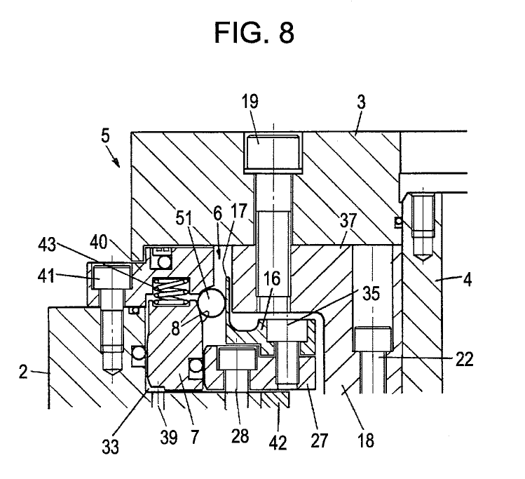

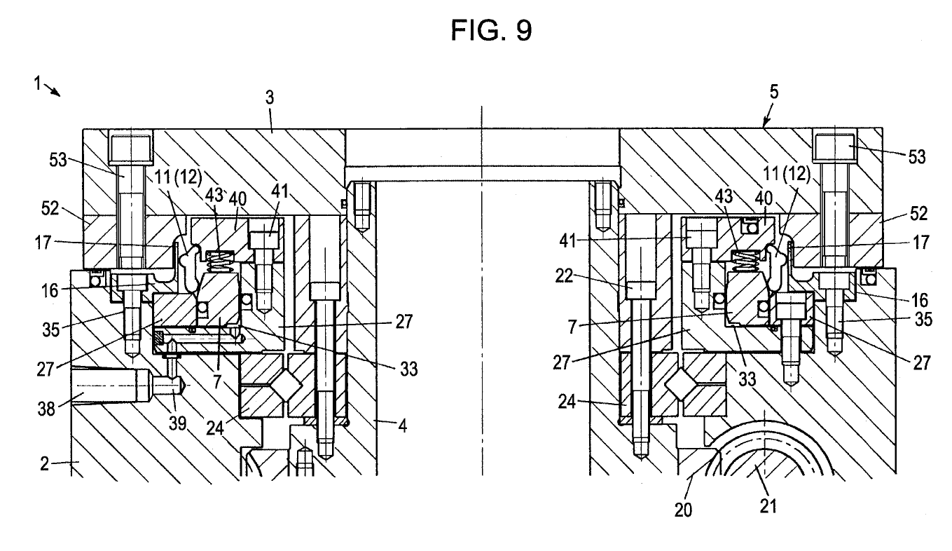

A clamp device 6 shown in FIG. 8 is an embodiment in which a configuration of pressing force conversion means 9 uses steel balls 51 instead of the lever members 12 used in, for example, the embodiment shown in FIG. 1. When a piston member 7 is advanced, a tapered surface 8 moves the steel balls 51 toward the center of a rotating shaft 4. Hence, the steel balls 51 cause a thin-wall cylindrical portion 17 to be pressed to a flange 37 of a bearing sleeve 18. Herein, the tapered surface 8 and the steel balls 51 define a force-increasing mechanism.

In the embodiments shown in FIGS. 1 to 8, the rotational body 5 (the bearing sleeve 18) serves as a member to be pressed that receives the pressing force from the pressing member 11, the thin-wall cylindrical portion 17 of the clamp member 16 surrounds the rotating shaft 4, and the pressing member 11 causes the pressing force to act inward in the radial direction. However, the clamp device 6 of the present invention is not limited thereto. As shown in FIG. 9, the clamp device 6 may have a configuration that causes a pressing force to act outward in the radial direction by a pressing member 11.

To be more specific, in a clamp device 6 shown in FIG. 9, a ring-shaped member to be pressed 52 is fixed to an outer peripheral portion of a lower surface of a rotary table 3. The member to be pressed 52 is attached to the rotary table 3 by attaching bolts 53. Alternatively, a member to be pressed 52 may be integrally formed with the rotary table 3 as a part of the rotary table 3. A clamp member 16 is attached to a surface of a housing 2 by attaching bolts 35. The clamp member 16 includes a thin-wall cylindrical portion 17 arranged to face an inner peripheral surface of the member to be pressed 52 in a non-contact state. Consequently, the member to be pressed 52 surrounds the thin-wall cylindrical portion 17.

Pressing members 11 (lever members 12) are arranged at positions at which the pressing members 11 face the inner peripheral surface of the member to be pressed 52 with the thin-wall cylindrical portion 17 interposed therebetween. When a piston member 7 is displaced, a tapered surface 8 of the piston member 7 causes a pressing force to act on the member to be pressed 52 through the lever members 12 outward in the radial direction. A pressure chamber 33 is formed by two annular case members 27.

The present invention may be implemented by still other embodiments. In the clamp device 6 using the lever member 12 shown in, for example, FIG. 1, an elastic member 54 formed of rubber, urethane, etc., may be arranged between the lever member 12 and a member (clamp member 16 in the illustrated embodiment) fixed to the housing 2 at a position on the inner side in the radial direction of the lever member 12, so as to contact both the lever member 12 and the member fixed to the housing 2, as shown in FIGS. 3, 4, and 7. With this configuration having the elastic member 54, the lever member 12 can be further reliably restored to an initial position (position during unclamping) because of an elastic force of the elastic member 54 when the operation is switched from clamping to unclamping (when the piston member 7 is moved in the unclamping direction).

In particular, the thin-wall cylindrical portion 17 is bent by a pressing force during clamping. If the pressing force is released, the thin-wall cylindrical portion 17 is restored to a state before the deformation because of the elasticity of the thin-wall cylindrical portion 17. Accordingly, the lever member 12 is restored to the initial position. The elastic member may be used as an auxiliary member for further reliably restoring. For example, in the illustrated embodiment, an end portion of the clamp member 16 on the effort portion 13 side slides on the member to which the clamp member 16 is fixed when the piston member 7 is displaced. If sliding is not smoothly performed, the lever member 12 may not be displaced outward in the radial direction although the piston member 7 is displaced in the unclamping direction, and the clamped state may be maintained. By using the elastic member, if the piston member 7 is moved in the unclamping direction when the operation is switched from clamping to unclamping, the lever member 12 is reliably displaced outward in the radial direction accordingly. With the provision of the elastic member, the clamped state can be prevented from being maintained.

As described above, the thin-wall cylindrical portion 17 and the thin-wall cylindrical portion 50 surrounding the rotating shaft 4 do not have to be provided, and the clamp member 16 may be omitted. The pressing member 11 may directly hold the rotating shaft 4 and a part that is rotated simultaneously with the rotating shaft 4.

In the embodiments described above, the pressing force conversion means 9 has the force-increasing function. However, the present invention is not limited thereto. The pressing force conversion means 9 may have any configuration as long as the configuration receives the pressing force when the piston member 7 is moved in the clamping direction and causes the pressing force in the radial direction to act on the rotating shaft 4 accordingly. For example, even when the configuration shown in FIG. 1 is employed, if the tapered surface 8 of the piston member 7 has an angle of 45 degrees to the axis of the rotating shaft 4, and a ratio of a distance a from the effort portion 13 to the fulcrum portion 15 to a distance b from the fulcrum portion 15 to the load portion 14 of the lever member 12 is 1:1, the lever member 12 no longer has the force-increasing effect. However, the present invention may have such a configuration that does not have the force-increasing effect.

### INDUSTRIAL APPLICABILITY

As described above, the rotary index device according to the present invention is not limited to the rotary table device in the embodiments, and may be applied to a device (main-shaft head) that supports a device (spindle unit) for rotating a spindle (main shaft) to which a tool is mounted and turns the spindle unit, and a part (device) that rotates the main-shaft head around an axis that is parallel to the Z axis of a machine tool. In the former case, the spindle unit corresponds to the rotation object member. In the later case, the main-shaft head corresponds to the rotation object member.

1. A rotary index device (1) in a machine tool, comprising a rotating shaft (4) provided rotatably in a housing (2), a rotation object member (3) being fixed to an end portion of the rotating shaft (4); and a clamp device (6) that causes a pressing force to act on a rotational body (5) including the rotating shaft (4) in a radial direction of the rotating shaft (4), and holds a rotational angular position of the rotational body (5) after indexing,
wherein the clamp device (6) includes a piston member (7) provided displaceably in a direction along a rotational axis of the rotating shaft (4) within the housing (2), the piston member (7) having a tapered surface (8) formed on a side surface thereof on a clamp position side; pressing force conversion means (9) arranged between the rotational body (5) and the piston member (7), for receiving a pressing force in the direction along the rotational axis of the rotating shaft (4) from the piston member (7) when the piston member (7) is displaced, converting the pressing force into a force in the radial direction of the rotating shaft (4), and causing the converted force to act on the rotational body (5); and urging means (10) for urging the piston member (7) in a direction in which the pressing force conversion means (9) generates the pressing force in the radial direction of the rotating shaft (4).

2. The rotary index device (1) in a machine tool according to claim 1, wherein the pressing force conversion means (9) includes a plurality of pressing members (11) provided between the piston member (7) and the rotational body (5) and arranged in a circumferential direction of the rotating shaft (4).

3. The rotary index device (1) in a machine tool according to claim 2, wherein the pressing members (11) are lever members (12) provided to extend in an axial direction of the rotating shaft (4), each lever member (12) having an effort portion (13), a fulcrum portion (15), and a load portion (14), the effort portion (13) formed at an end portion of the lever member (12) and contacting the tapered surface (8) of the piston member (7), the fulcrum portion (15) rotatably retained by the housing (2), the load portion (14) facing the rotating shaft (4), the lever member (12) formed such that a distance from the effort portion (13) to the fulcrum portion (15) is larger than a distance from the fulcrum portion (15) to the load portion (14).

4. The rotary index device (1) in a machine tool according to any one of claims 1 to 3, wherein the clamp device (6) includes a clamp member (16) arranged between the pressing force conversion means (9) and the rotational body (5), and fixed to the housing (2) non-rotatably relative to the housing (2), the clamp member (16) facing a surface of the rotational body (5), the surface which receives the pressing force, the clamp member (16) having a ring-shaped, thin-wall cylindrical portion (17, 50) that is deformable in the radial direction of the rotating shaft (4).

5. The rotary index device (1) in a machine tool according to any one of claims 1 to 3, wherein the tapered surface (8) of the piston member (7) has an angle that is smaller than 45 degrees to the rotational axis.
